(19) United States
(12) Patent Application Publication
(10) Pub. No.: US 2021/0186042 A1
(43) Pub. Date: Jun. 24, 2021

(54) USE OF HEXOSE OXIDASE AND/OR CELLOBIOSE OXIDASE FOR REDUCTION OF MAILLARD REACTION

(71) Applicant: Chr. Hansen A/S, Hoersholm (DK)

(72) Inventors: Martin LUND, Hoersholm (DK); Camilla Lund NIKOLAJSEN, Hoersholm (DK); Johannes Maarten VAN DEN BRINK, Hoersholm (DK)

(73) Assignee: Chr. Hansen A/S, Hoersholm (DK)

(21) Appl. No.: 17/057,522

(22) PCT Filed: May 23, 2019
(86) PCT No.: PCT/EP2019/063291

§ 371 Date: Nov. 20, 2020

(30) Foreign Application Priority Data
May 24, 2018 (EP) 18173976.4

(51) Int. Cl. A23C 19/06; A23C 19/05; A23C 19/068

(52) U.S. Cl. CPC A23C 19/063; A23C 19/054; C12Y 101/99018; C12Y 101/03005; A23C 19/0684

(57) ABSTRACT

A process for the reduction of Maillard reaction (and thereby browning) in a cheese food product, wherein the process comprises contacting the product with a hexose oxidase (EC1.1.3.5) and/or cellobiose oxidase (EC 1.1.99.18) enzyme.

### FIELD OF THE INVENTION

The present invention relates to a process for the reduction of Maillard reaction (and thereby browning) in a cheese food product, wherein the process comprises contacting the product with a hexose oxidase (EC1.1.3.5) and/or cellobiose oxidase (EC 1.1.99.18) enzyme.

### BACKGROUND ART

A relatively high concentration of galactose can result in “browning” during heating of cheeses as it is often described when e.g. mozzarella cheese is produced by S. thermophilus (ST) for e.g. pizza production.

The browning phenomenon is believed to be due to the Maillard reaction where galactose as reducing sugar is reacting with amino groups of amino acids/peptides.

Beside this major problem during pizza cheese production, excess amounts of free galactose can also lead to post acidification problems and imbalance in the flora of other dairy product, such as e.g. soft cheeses.

Many pizza manufacturers bake pizza at temperatures >260° C. At these high temperatures the propensity of the cheese to brown excessively has become a particular concern to the mozzarella industry.

WO02/39828A2 (Danisco) describes use of hexose oxidase (HOX) (EC1.1.3.5) enzyme for reduction of Maillard reaction (and thereby browning) in a cheese such as mozzarella cheese.

Hexose oxidase (EC1.1.3.5) uses “Cu cation” as active cofactor and cellobiose oxidase (EC 1.1.99.18) uses flavin adenine dinucleotide (FAD) as cofactor for this reason and others, they are different enzymes and therefore have different EC classification number.

The commercially available product Lactoyield® (Chr. Hansen A/S, Denmark) comprises a cellobiose oxidase (EC 1.1.99.18), which herein alternatively may be termed lactose oxidase (LOX) or carbohydrate oxidase.

EP1041890B1 (Novozymes) and the article of Feng Xu et al (Eur. J. Biochem. 268, 1 13 6-1 142 (2001)) describe the cellobiose oxidase (EC 1.1.99.18) as present in Lactoyield®—these prior art documents do no describe use of the cellobiose oxidase (EC 1.1.99.18) for reduction of Maillard reaction (and thereby browning) in a food or feed product such as e.g. mozzarella cheese.

The mature amino acid sequence of the cellobiose oxidase (EC 1.1.99.18) as present in Lactoyield® is position 23-495 of SEQ ID NO: 2 of EP1041890B1, which starts with Gly in position 23 and ends with Lys in position 495.

The polypeptide of position 23-495 of SEQ ID NO: 2 of EP1041890B1 is provided herein as position 1-473 of SEQ ID NO: 1.

### SUMMARY OF THE INVENTION

The problem to be solved by the present invention is to provide a novel process for the reduction of Maillard reaction (and thereby browning) in a food or feed product (preferably a dairy food product such as e.g. a cheese—more preferably a mozzarella cheese).

The solution is based on that the present inventors identified that the cellobiose oxidase (EC 1.1.99.18) enzyme as present in Lactoyield® is well suited at solving above mentioned problem (see e.g. working Examples herein).

As discussed above—cellobiose oxidase (EC 1.1.99.18) may alternatively be termed lactose oxidase (LOX) or carbohydrate oxidase.

In Example 1 Lactoyield® was added to the surface of a shredded mozzarella cheese and after 14 days of cold storage there was obtained a significant reduction of galactose and browning (after heating to 100° C. for 70 min) was significantly reduced.

Example 2 demonstrates that Lactoyield® (LOX) is heat stable.

Example 3 shows that by addition of Lactoyield® (LOX) directly to the milk before acidification of the milk it was possible to make a cheese product comprising a significant reduced amount of galactose.

As discussed below in relation to the conclusions of working Example 3—adsorption of LOX onto a particle avoids the transfer of the enzyme to whey. This not only preserves the value of whey, but also allows one to dose only a tenth of the required enzyme. Presence of LOX in cheese curd catalyzes the oxidation of galactose to galactonic acid which will result in reduced browning upon baking. Above discussed WO02/39828A2 (Danisco) does not even mention the possibility of adsorption of the therein described hexose oxidase (HOX) enzyme onto particles.

Example 4 shows that Lactoyield® (LOX) works well for reducing browning even in presence of anticaking agents.

With respect to herein discussed positive results of Example 3 relating to adsorption of oxidase enzyme—without being limited to theory, there is prima facie no reason to believe that adsorption of HOX onto a particle could not give an improved process over the processes described in above discussed WO02/39828A2 (Danisco), where all working examples essentially only describes “spray on” addition of the HOX enzyme to the surface of the product (e.g. mozzarella cheese).

There is prima facie no reason to believe that the herein discussed positive results should not be generally obtained by use of other suitable hexose oxidase (EC1.1.3.5) and/or cellobiose oxidase (EC 1.1.99.18).

A reason for this is that enzymes of the same EC class generally have a number of feature in common, which may be seen as a technical reason for that they are designated the same EC class.

Accordingly, a first aspect of the invention relates to a process for the reduction of Maillard reaction in a cheese food product, wherein the process comprises following steps:

(a): contacting milk with particles comprising bound/encapsulated hexose oxidase (EC1.1.3.5) and/or cellobiose oxidase (EC 1.1.99.18) enzyme before, during or after acidification of the milk;

(b) coagulating the acidified milk of (i) and separating the curd from the whey;

(c): storing the curd of (ii) under conditions, where the oxidase enzymes present in the curd performs oxidation of galactose present in the curd;

(d): making further adequate steps to finally end up with the cheese product comprising a reduced amount of galactose and thereby a product with a reduction of Maillard reaction.

Alternatively expressed, the first aspect and herein relevant embodiments thereof may be formulated as use of a hexose oxidase (EC1.1.3.5) and/or cellobiose oxidase (EC 1.1.99.18) enzyme for the reduction of Maillard reaction in a food or feed product (preferably a dairy food product), wherein the use involves a process comprising contacting the product with a hexose oxidase (EC1.1.3.5) and/or cellobiose oxidase (EC 1.1.99.18) enzyme.

As understood by the skilled person in the present context—the term “reduction of Maillard reaction” relates to that the extent of a Maillard reaction is reduced and/or the period of time required for completion of a Maillard reaction is increased.

Embodiment of the present invention is described below, by way of examples only. As understood by the skilled person in the present context, a combination of a preferred embodiment with another preferred embodiment may be seen as an even more preferred embodiment.

### DRAWINGS

FIG. 1: Test of browning of mozzarella cheese shreds. Single shreds placed in well and plate heated at 100 C for 75 min. Each column show replicates of cheese subjected to different treatment with LOX. Samples 1-3: Shreds of Mozzerella cheese made using Hannilase XP, treated with LOX and stored for 14 days at 5° C. 1: control with no LOX, 2: 0.01 LOXU/g, 3: 0.02 LOXU/g. Samples 10-12: Mozzerella cheese made using CHY-MAX M, treated with LOX and stored for 14 days at 5° C. 10: control with no LOX, 11: 0.01 LOXU/g, 12: 0.02 LOXU/g.

FIG. 2: Same sample treatment as in FIG. 1, but with addition of catalase Catazyme (0.1 U per g cheese).

FIG. 3: Data demonstrating that Lactoyield® (LOX) works even in presence of anti-caking agents—see Example 3 herein for further details. Black 0 LOXU/g, blue 0.01 LOXU/g, red 0.05 LOXU/g. Vat 4 is a control cheese sample with high level of galactose (>0.5%) and Gouda45+ is a control cheese sample with no or very little residual galactose.

### DETAILED DESCRIPTION OF THE INVENTION

Cellobiose Oxidase (EC 1.1.99.18) Enzyme

Preferably, the cellobiose oxidase (EC 1.1.99.18) enzyme is an enzyme:
(i): comprising the polypeptide sequence of position 23-495 of SEQ ID NO: 2 of EP1041890B1, which starts with Gly in position 23 and ends with Lys in position 495; or
(ii): a variant of (i), wherein the variant comprises less than 20 (preferably less than 10, more preferably less than 5) amino acid alterations (preferably a substitution, a deletion or an insertion most preferably a substitution) as compared to polypeptide sequence of (i).

The polypeptide of position 23-495 of SEQ ID NO: 2 of EP1041890B1 is provided herein as position 1-473 of SEQ ID NO: 1.

Accordingly, preferably the cellobiose oxidase (EC 1.1.99.18) enzyme is an enzyme:
(i): comprising the polypeptide sequence of position 1-473 of SEQ ID NO: 1, which starts with Gly in position 1 and ends with Lys in position 473; or
(ii): a variant of (i), wherein the variant comprises less than 20 (preferably less than 10, more preferably less than 5) amino acid alterations (preferably a substitution, a deletion or an insertion most preferably a substitution) as compared to polypeptide sequence of (i).

Starting from an enzyme of interest (e.g. the cellobiose oxidase (EC 1.1.99.18) enzyme of item (i) above) it is routine work for the skilled person to make a variant with the same/similar cellobiose oxidase activity (e.g. by making so-called conservative changes e.g. a change of an amino acid to similar amino acid (e.g. change of a hydrophobic amino acid to another hydrophobic amino acid).

Said in other words it is routine work for the skilled person to make a variant of item (ii) above accordingly, it is not believed necessary to describe/discuss this in great details herein.

Hexose Oxidase (EC1.1.3.5) Enzyme

The full length polypeptide sequence (including pre/signal sequence i.e. upstream of mature peptide) of the hexose oxidase (HOX) enzyme discussed in WO02/39828A2 (Danisco) is shown herein as polypeptide sequence of position of SEQ ID NO: 2.

It has CAS NO:9028-75-5 and UniProt reference number “UniProtKB—P93762 (HOX_CHOCR)” (http://www.uniprot.org/uniprot/P93762).

Preferably, the hexose oxidase enzyme is an enzyme:
(i): comprising the mature/active part of the polypeptide sequence of SEQ ID NO: 2 herein; or
(ii): a variant of (i), wherein the variant comprises less than 20 (preferably less than 10, more preferably less than 5) amino acid alterations (preferably a substitution, a deletion or an insertion—most preferably a substitution) as compared to polypeptide sequence of (i).

An example of a mature/active part of the polypeptide sequence of SEQ ID NO: 2 herein of item (i) is the HOX enzyme commercial available Danisco/DuPont product Grindamyl Surebake 800—it is used in a working example herein.

Preferred Process Parameters

Based on the technical teaching herein and the common general knowledge of the skilled person, it is routine work for the skilled person to optimize relevant process parameters (e.g. temperature, time, amount of enzyme used, etc.) in order to get reduction of Maillard reaction (and thereby browning) in a food or feed product (preferably a dairy food product)—accordingly, it is herein not required to describe this in great details.

The enzyme may also be added in dry or powder form. When in wet or dry form the enzyme may be combined with other components for contact with the foodstuff. For example when the enzyme is in dry form it may be combined with an anticaking agent.

In some aspects the present invention further comprises the step of contacting the food or feed product with a catalase.

It will be appreciated by one skilled in the art that in the practice of the present invention one contacts the dairy food product with a sufficient amount of enzyme to prevent and/or reduce a Maillard reaction—it is routine work for the skilled person to identify such a sufficient amount of enzyme.

Typical amounts of enzyme which may be contacted with the foodstuff are from 0.05 to 5 U/g (units of enzyme per gram of food product), from 0.05 to 3 U/g, from 0.05 to 2 U/g, from 0.1 to 2 U/g, from 0.1 to 1.5 U/g, and from 0.5 to 1.5 U/g.

As discussed in working Example herein—the amount of Lactoyield® (LOX) may be determined according to the public known so-called LOXU/g unit.

LOXU/g unit is publicly available/known (and thereby possible to determine for the skilled person) from the public available Product Information sheet for Lactoyield®, Chr. Hansen A/S Denmark; Version: 5 PI GLOB EN 02-24-2017—the Product Information sheet for Lactoyield® may be obtained upon request to Chr. Hansen A/S Denmark or by simply buying of the Lactoyield® product.

It may be preferred that typical amounts of cellobiose oxidase (EC 1.1.99.18) enzyme which may be contacted with the foodstuff are from 0.0001 to 10.0 LOXU/g, such as from 0.001 to 5.0 LOXU/g or more preferably from 0.001 to 1.0 LOXU/g or even more preferably from 0.005 to 0.1 LOXU/g.

In relation to step (a) above—the enzyme may be contacted with the milk in any suitable form—e.g. contacting liquid enzyme with the milk.

Working Example 3 described particles with a particle diameter distribution that works very well—i.e. avoids the transfer of the enzyme to whey. There is no reason to believe that particles with a relatively lower/higher particle diameter distribution than used in Example 3 should not work reasonable well.

Accordingly, in a preferred embodiment the particles comprising bound/encapsulated oxidase enzyme of step (a) are particles having a particle diameter (D(v,0.1)) distribution of at least 10 nm and a particle diameter (D(v,0.9)) distribution of less than 500 μm—more preferably a particle diameter (D(v,0.1)) distribution of at least 0.1 μm and a particle diameter (D(v,0.9)) distribution of less than 200 μm—even more preferably a particle diameter (D(v,0.1)) distribution of at least 0.5 μm and a particle diameter (D(v,0.9)) distribution of less than 100 μm.

According to the art, the term “D(v,0.1)” represents the particle diameter at which 10% of the particle distribution is below and “D(v,0.9)” represents the particle diameter at which 90% of the particle distribution is below.

Consequently, if e.g. D(v,0.1)=2 μm and D(v,0.9)=200 μm then will there be relatively many (more than 90%) of the particles that have a particle diameter above 2 μm and there will be relatively many (at least 90%) of the particles that have a particle diameter less than 200 μm =>the majority of the particles will have a particle diameter within the range from 2 μm to 200 μm.

As known in the art in relation to irregularly shaped particles is generally used the concept of “equivalent spherical diameter”, in which some physical property of the particle is related to a sphere that would have the same property (e.g. same volume) accordingly, particle diameter relates herein the well-known concept of “equivalent spherical diameter”.

According to the art the term “v” in the term “D(v,0.1)” and “D(v,0.9)” relates to volume i.e. volume distribution.

It is routine work for the skilled person to measure the herein relevant “D(v,0.1)” and “D(v,0.9)” values—e.g. by using a suitable Malvern apparatus or another suitable apparatus.

In working Example 3 herein the particles of step (a) was made of agarose. The skilled person knows a number of suitable different particle types that are acceptable/authorized for food/feed product manufacturing and any of such suitable particle types may in principle be used as step (a) suitable particle types.

It may be preferred that the particles in step (a) are at least one particle type selected from the group consisting of: cellulose and derivatives hereof, agarose, dextran, polymers such as e. g. polyacrylates, polystyrene, polyacrylamide, polymethacrylate or copolymers.

As evident to the skilled person in the present context the term “at least one” refers to that the particles in step (a) may of course be different particle types e.g. 50% of one type and 50% of another type.

The international patent application with PCT application number: PCT/EP2018/050317 was filed 8 Jan. 2018.

PCT/EP2018/050317 describes particles so-called CGMP oligomer particles wherein CGMP oligomer is cross-linked, via intermolecular covalent isopeptide bonds, casein glycomacropeptide (CGMP) oligomers (CGMP oligomers), wherein monomeric CGMP is the peptide containing the amino acid residues 106-169 of K-casein and monomers of

CGMP oligomers are monomeric CGMP. Working Example 6 of PCT/EP2018/050317 describes CGMP oligomer particles comprising encapsulation lactose oxidase (LOX,)Lactoyield®.

PCT/EP2018/050317 does not directly and unambiguously disclose use of LOX in a process for the reduction of Maillard reaction in a food or feed product as discussed herein—for instance is the term “browning” not even mentioned in PCT/EP2018/050317.

It may be preferred that the particles in step (a) are at least one particle type selected from the group consisting of: CGMP oligomer particles, wherein CGMP oligomer is cross-linked, via intermolecular covalent isopeptide bonds, casein glycomacropeptide (CGMP) oligomers (CGMP oligomers), wherein monomeric CGMP is the peptide containing the amino acid residues 106-169 of κ-casein and monomers of CGMP oligomers are monomeric CGMP.

Food or Feed Product

Useful food/feed product starting materials include any relevant material e.g. material which is conventionally subjected to a lactic acid bacterial fermentation step such as milk (e.g. soy milk or cow milk, preferably cow milk), vegetable materials, meat products, fruit juices, must, doughs and batters.

Preferably, the product is a dairy food product, preferably a fermented dairy food product.

The fermented products, which are obtained by the method, include as typical examples dairy products such as fermented milk, yogurt, cheese, including fresh cheese products, soft cheese products, cheddar, mozzarella or buttermilk.

In a preferred embodiment, the dairy product is soft cheese, cheddar cheese, pasta filata cheese or mozzarella cheese more preferably, the dairy product is pasta filata cheese, cheddar cheese or mozzarella cheese most preferably the dairy product is mozzarella cheese or cheddar cheese (preferably used for making pizza).

Example 2 herein demonstrates that Lactoyield® (LOX) is more heat stable than hexose oxidase (HOX) described in above discussed WO02/39828A2 (Danisco).

This is a significant advantage of LOX over HOX, since e.g. a number of food/feed products (e.g. dairy food products) are made by a process that involves a heating step.

For instance is Mozzarella cheese made by a process that involves a heating step. As known in the art—Mozzarella is made by the so-called the pasta filata method (i.e. Mozzarella is an example of a so-called pasta filata cheese).

Cheeses manufactured from the pasta filata technique may undergo a plasticizing and kneading treatment of the fresh curd in hot water (i.e. a heating step, where the temperature may e.g. be from 50 to 95° C.).

Accordingly, in a preferred embodiment the food or feed product is a product made by a process that involves a heating step and the contacting of the product with the cellobiose oxidase (EC 1.1.99.18) enzyme has been done before the heating step is made. In relation to this embodiment, a preferred product may be a pasta filata cheese (such as e.g. Mozzarella cheese).

The heating step may e.g. be a heating step to a temperature above 40° C., such as above 50° C. or such as above 70° C.

As discussed above, many pizza manufacturers bake pizza at temperatures >260° C. and there may then be significant browning problems.

Accordingly, in a preferred embodiment the food or feed product is a product used in a process (e.g. for making pizza) involving a heating step to a temperature above 40° C., such as above 80° C. or such as above 100° C. or such as above 150° C. In relation to this embodiment, a preferred product may be a pasta filata cheese (such as e.g. Mozzarella cheese) which may be used for making pizza or alternatively expressed pizza cheese.

Shredded cheese (such as e.g. mozzarella) commercially available for the consumer normally contains anticaking agent. The role of anticaking agent is to prevent shreds of cheese from sticking to each other and forming a lump of cheese that cannot be spreads easily on e.g. a pizza.

Anti-caking agent is normally composed of starch from e.g. potato and corn. Since starch is a natural polysaccharide containing high amounts of reducing sugar groups one would anticipate starch to contribute significantly to Maillard browning. Thus, a solution only controlling galactose reduction may not be useful for a shredded product applied anticaking agents such as starch.

Example 4 shows that Lactoyield® (LOX) works well even in presence of starch anticaking agents—more specially for making shredded mozzarella cheese product comprising starch anticaking agents.

Accordingly, in a preferred embodiment the food or feed product (preferably a food product, such as preferably a shredded cheese product (e.g. mozzarella cheese) is a product comprising starch anticaking agents (e.g. starch from potato and/or corn).

As known in the art—the term “shredded cheese” relates to a cheese that has been sent through a shredder to create shreds of cheese. Shredded cheese is generally used as an ingredient. It is mixed in with other ingredients or used as a topping for foods such as salads, sandwiches, soup, pizza, lasagna, and many other savory dishes. It is available in many different varieties, such as mozzarella, Cheddar, Parmesan, and Swiss.

Accordingly, preferably the shredded cheese is a mozzarella shredded cheese, a Cheddar shredded cheese, a Parmesan shredded cheese or a Swiss shredded cheese.

In further embodiments, the substrate material is a starting material for an animal feed such as silage, e. g. grass, cereal material, peas, alfalfa or sugar-beet leaf, where bacterial cultures are inoculated in the feed crop to be ensiled in order to obtain a preservation hereof, or in protein rich animal waste products such as slaughtering offal and fish offal, also with the aims of preserving this offal for animal feeding purposes.

### EXAMPLES

### Example 1

### LactoYield (LOX) Experimental Data

Below is referred to that enzyme dosage was LOXU per g cheese. LOXU was determined according to the public available Product Information sheet for Lactoyield®, Chr. Hansen A/S Denmark; Version: 5 PI GLOB EN 02-24-2017. As discussed below in this Example were used around 0.01 0.02 LOXU/g.

In this experiment Lactoyield® was added to the surface of a shredded mozzarella cheese. A mozzarella cheese produced either using Hannilase XP (mucor pepsin XL-typw) or CHY-MAX M (camel chymosin) and the same culture was shredded and storage at −18° C. An amount of 5.0 g of cheese shreds was transferred to a 15 ml tube and added 0.5 ml Lactoyield® enzyme diluted in 0.05 M sodium acetate pH 5.2. Enzyme dosage was 0, 0.01 or 0.02 LOXU per g cheese. The tube was closed with an air tight lid, inverted for 20 min and stored at 5° C. After 14 days of storage the sample was analyzed for ability to brown and for galactose.

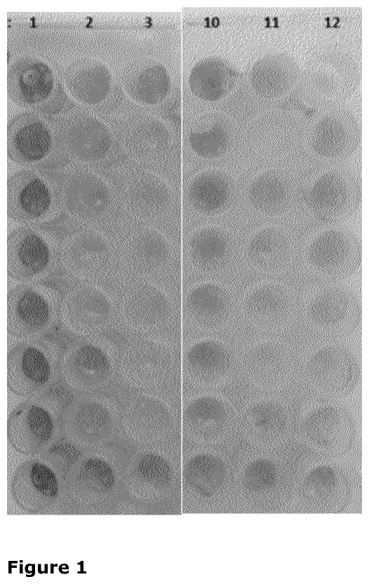

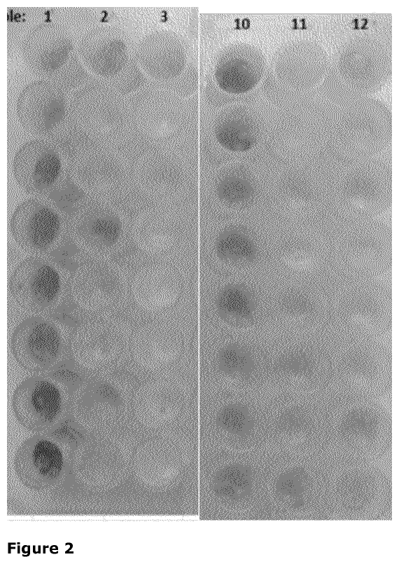

Browning was studied by placing single shreds of cheese in a well of a 96 well plate. The plate was heated to 100° C. for 70 min. From the result shown in FIG. 1 and FIG. 2 it is seen that treatment of shredded mozzarella cheese with LOX at 0.01-0.02 LOXU/g reduced the ability of the cheese to brown. Addition of catalase (Catazyme) seemed to increase the effect of the Lactoyield® enzyme and resulted in even less browning.

The sample was analyzed for galactose by dispersing 4 g cheese in 25 ml water to homogeneity and inverting the tube for 30 min. LOX enzyme in the suspension was inactivated by immersing the sample in a water bath at 80° C. for 25 min. The aqueous phase was recovered after centrifugation and kept at −18° C. before analysis. Galactose was quantified by HPLC. In Table 1 it is seen that the concentration of galactose declines to a level less than 200 mg/100 g when the sample of cheese is treated with LOX. Reduction of galactose upon LOX addition is in good agreement with the observed reduction of browning.

TABLE 1
Measurement of residual galactose in cheese shreds.

| | LactoYield | Catazyme | Residual galactose |
|---|---|---|---|
| Coagulant | (LOX-U/g) | (U/g) | (mg/100 g) |
| CHY-MAX M | 0 | 0 | 570 |
| CHY-MAX M | 0.01 | 0 | 318 |
| CHY-MAX M | 0.02 | 0 | 200 |
| Hannilase | 0 | 0 | 575 |
| Hannilase | 0.01 | 0 | 304 |
| Hannilase | 0.02 | 0 | 249 |
| CHY-MAX M | 0 | 0.1 | 543 |
| CHY-MAX M | 0.01 | 0.1 | 331 |
| CHY-MAX M | 0.02 | 0.1 | 158 |
| Hannilase | 0 | 0.1 | 584 |
| Hannilase | 0.01 | 0.1 | 340 |
| Hannilase | 0.02 | 0.1 | 296 |

### Example 2

### LactoYield (LOX) is More Heat Stable than HOX

An inherent step in production of pasta filata cheese is heat stretching of the curd. Here freshly made loaves of curd are subjected to hot water in a stretching process that serves to plasticize the curd. In the so called cooker curd stretched in water having temperatures up to e.g. 80-85° C. for holding times of 2-3 min. The treatment result in curd temperatures as high as 65-70° C. The activity of enzymes that are added cheese milk and retained in curd must be preserved during the entire process of cheese making. To assess the potential impact of a heat treatment of LOX, a buffered solution of the enzyme was heated to temperatures in the range 50-80° C. for various holding times from 5-30 min. The buffer employed was a 50 mM sodium acetate of pH 5.2, which is the target pH of mozzarella curd entering heat stretching. After heating the enzyme was placed on ice and activity was measured. The enzymes HOX (commercial available Danisco/DuPont product Grindamyl Surebake 800 described in above discussed WO02/39828A2) and GOX (Glucose oxidase—commercial available product G6125 from Sigma) were included as reference. The same assay was used for all measurement of enzyme activity of the three enzymes. Activity measurement was done in a coupled peroxidase assay using 4-aminoantipyrine (4AA) and N-ethyl-N-sulfopropyl-m-toluidine (Tops) as the chromogenic agents according to Eur. J. Biochem. 268, 1136-1142 (2001). Activity was converted to relative activity by normalizing to activity of an untreated control sample of the respective enzyme at same dilution. Plotting activity as function of holding time resulted in a single exponential decay from which a rate constant was calculated. From the Arrhenius equation describing the relationship between rate constant and temperature, rate constants were calculated at temperatures 50-72° C. and converted into half-life values for a 1^{st} order reaction.

From the Table it is seen that LOX is stable at temperatures 65-72° C. whereas GOX and HOX have lost considerable activity within 2-5 min.

TABLE 2
Half-life values in min for heat inactivation of LOX, GOX and HOX at pH 5.2.

| Enzyme | t_{1/2} (50° C.) | t_{1/2} (55° C.) | t_{1/2} (60° C.) | t_{1/2} (65° C.) | t_{1/2} (70° C.) | t_{1/2} (72° C.) |
|---|---|---|---|---|---|---|
| LOX | 3763 | 912 | 231 | 60.8 | 16.7 | 10.0 |
| GOX | 101 | 39.2 | 15.7 | 6.42 | 2.71 | 1.93 |
| HOX | 57.4 | 24.6 | 10.8 | 4.89 | 2.26 | 1.67 |

### Example 3

### Addition of LactoYield (LOX) to Cheese Milk—Particles Best

Below is referred to enzyme “bound to particles”—the particles had a particle diameter (D(v,0.1)) distribution of at least 2 μm and a particle diameter (D(v,0.9)) distribution of less than 200 μm.

The particle was made of agarose (Workbeads WB40S)—D(v,0.5) of 40 μm.

A down scaled cheese model was made in 96 well plates employing a process simulating cheese making. Skim milk was added CaCl₂ to 0.5 g/l, glucono deltalactoneglucone (GDL) to 0.9 g/l for chemical acidification and Ha-lactase to 5 NLU/ml for hydrolyzing lactose to glucose and galactose. Immediately after dissolving GDL, the milk was transferred to a 96 deep well plate with 1.25 ml in each well. The enzyme LactoYield (LOX) was added at different levels either as liquid enzyme or as bound to particles with particle diameter as given above. Catalase was added as liquid enzyme at different levels. Addition of LOX marked start of the experiment (t=0). The plate was heated to 30° C. and was mixed by shaking. At t=10 min coagulant was added to each well (0.04 IMCU/ml) and shaking of the plate stopped five minutes later. Addition of coagulant resulted in coagulation of the milk to rennet curd. At t=35 min the curd was cut by moving a pipette tip back and forth a few times before increasing temperature to 40° C. and starting shaking of the plate. At t=60 min part of the whey was removed and displaced with water and shaking continued. A sample of whey was kept for analysis of LOX activity. Finally at t=70 min, the plate was spun in a centrifuge at 3000 ppm for 20 min and whey was removed by inversion of the plate. In the plate remained a small piece of rennet curd. The curd was stored at 5° C. and samples were taken for analysis after 0, 4, 8, and 12 days. Curd was dissolved in 1.0 ml 0.5 M Na3-citrate, and sugar extracted from the dissolved rennet curd by lowering pH to 4.5 with hydrochloric acid and taking a sample of the supernatant after centrifugation. Galactose was analyzed using an enzymatic assay kit from Megazyme (K-LACGAR). Activity of LOX in whey was measured using a colorimetric assay employing 2,6-dichloroindophenol as electron acceptor.

The results demonstrated that a significant fraction of the LOX activity is transferred to whey when the enzyme is added as a liquid formulation. When the LOX enzyme is bound to a 40 μm particle, the enzyme could not be detected in whey. This suggests that the enzyme partitions selectively to curd when associated with a micron size particle.

Results relating to development of galactose in the curd during storage at 5° C. showed that control without LOX added has the same content of galactose during the 13 days storage period. In curd made with LOX there is a decline in galactose during storage. At the end of storage galactose had decreased to <200 mg/100 kg (<0.2%). This shows that the lactose oxidase had oxidized galactose to galactonic acid in cheese curd during storage. It is most likely that the reduction of galactose will result in the lower browning of the cheese curd.

In conclusion, adsorption of LOX onto a particle avoids the transfer of the enzyme to whey. This not only preserves the value of whey, but also allows one to dose only a tenth of the required enzyme. Presence of LOX in cheese curd catalyzes the oxidation of galactose to galactonic acid which will result in reduced browning upon baking.

### Example 4

### LactoYield (LOX) Works Even in Presence of Anticaking Agents

The experiment reported in Example 1 was based on cheese shredded for the purpose. Shredded cheese commercially available for the consumer always contains anticaking agent. The role of anticaking agent is to prevent shreds of cheese from sticking to each other and forming a lump of cheese that cannot be spreads easily on e.g. a pizza. Anti-caking agent is composed of starch from e.g. potato and corn. Since starch is a natural polysaccharide containing high amounts of reducing sugar groups one would anticipate starch to contribute significantly to Maillard browning. Thus, a solution only controlling galactose reduction may not be useful for a shredded product applied anticaking agents such as starch.

LOX can oxidize polymeric carbohydrates unlike its functional analogs, HOX and GOX (Eur. J. Biochem. 268, 1136-1142, 2001). To test if the activity of LOX towards starch was high enough to control browning of mozzarella cheese with anticaking agent, the experiment of example 1 was repeated using shredded cheese from the supermarket having potato starch on the ingredient list.

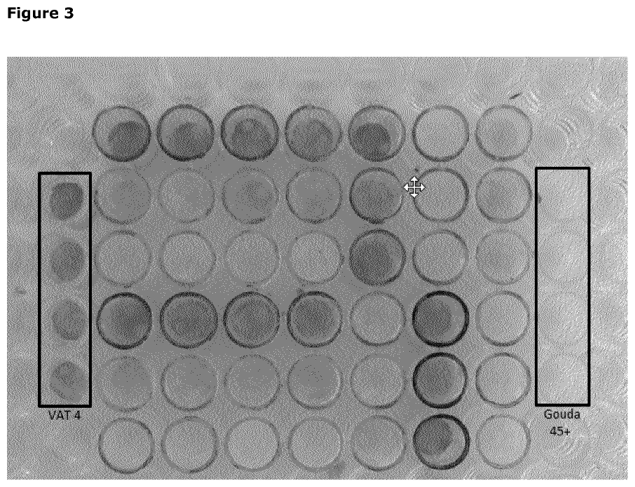

LOX was applied to the surface of shredded cheese and stored in tubes with tightly closed lids. After 2 weeks storage at 4° C. browning was tested. From the result shown in FIG. 3 herein it is seen that LOX treatment of shredded mozzarella cheese containing potato starch has a strong influence on the color of the cheese after heating to 100° C. for 100 min, where addition of LOX gave significant less browning.

### REFERENCES

1: WO02/39828A2 (Danisco)

2: EP1041890B1 (Novozymes)

3: Article of Feng Xu et al (Eur. J. Biochem. 268, 1136-1142 (2001))

1. A process for reducing Maillard reaction in a cheese food product, comprising:
(a) contacting milk with particles comprising bound or encapsulated hexose oxidase (EC1.1.3.5) enzyme and/or bound or encapsulated cellobiose oxidase (EC 1.1.99.18) enzyme before, during or after acidification of the milk;
(b) acidifying and coagulating the milk to obtain curd comprising the oxidase enzymes and whey, and separating the curd from the whey;
(c) storing the curd under conditions where the oxidase enzymes present in the curd oxidize galactose present in the curd;
(d): further processing the curd to obtain the cheese food product,
wherein the obtained cheese food product comprises a reduced amount of galactose and thereby a reduced Maillard reaction.

2. The process of claim 1, wherein the hexose oxidase enzyme:
(i) is an enzyme comprising the mature/active part of the amino acid sequence of SEQ ID NO: 2; or
(ii) is a variant of (i), wherein the amino acid sequence of the variant comprises less than 20 amino acid alterations as compared to the amino acid sequence of (i).

3. The process of claim 1, wherein the hexose oxidase enzyme comprises the mature/active part of the amino acid sequence of SEQ ID NO: 2.

4. The process of claim 1, wherein the cellobiose oxidase enzyme:
(i) is an enzyme comprising the amino acid sequence of positions 1-473 of SEQ ID NO: 1; or
(ii) is a variant of (i), wherein the amino acid sequence of the variant comprises less than 20 amino acid alterations as compared to the amino acid sequence of (i).

5. The process of claim 1, wherein the cellobiose oxidase comprises the amino acid sequence of positions 1-473 of SEQ ID NO: 1, and the amount of the cellobiose oxidase enzyme that is contacted with the milk is from 0.001 to 1.0 LOXU/g.

6. The process of claim 1, wherein the particles have a particle diameter (D(v,0.1)) distribution of at least 0.1 μm and a particle diameter (D(v,0.9)) distribution of less than 200 μm.

7. The process of claim 1, wherein the particles are of at least one particle type selected from cellulose and cellulose derivatives, agarose, dextran, polyacrylate, polystyrene, polyacrylamide, polymethacrylate, copolymers, and casein glycomacropeptide (CGMP) oligomer particles, wherein the CGMP oligomer particles comprise CGMP oligomers cross-linked via intermolecular covalent isopeptide bonds, wherein the CGMP oligomers are oligomers of monomeric CGMP having the amino acid sequence of amino acid residues 106-169 of κ-casein.

8. The process of claim 1, wherein the cheese food product is pasta filata cheese.

9. The process of claim 8, wherein step (d) comprises heating the curd to a temperature above 40° C.

10. The process of claim 1, wherein the cheese food product is a pasta filata cheese used in a process involving a heating step to a temperature above 100° C.

11. The process of claim 1, wherein the cheese food product is a shredded cheese product comprising starch anticaking agents, wherein the shredded cheese product is mozzarella cheese, cheddar cheese, parmesan cheese or Swiss cheese.

12. A process for reducing Maillard reaction in a cheese food product, comprising contacting a cheese food product with particles comprising bound or encapsulated hexose oxidase (EC1.1.3.5) enzyme and/or bound or encapsulated cellobiose oxidase (EC 1.1.99.18) enzyme.

13. The process of claim 12, wherein the hexose oxidase enzyme (i) is an enzyme comprising the mature/active part of the amino acid sequence of SEQ ID NO: 2; or (ii) is a variant of (i), wherein the amino acid sequence of the variant comprises less than 20 amino acid alterations as compared to the amino acid sequence of (i).

14. The process of claim 12, wherein the hexose oxidase enzyme comprises the mature/active part of the amino acid sequence of SEQ ID NO: 2.

15. The process of claim 12, wherein the cellobiose oxidase enzyme is an enzyme comprising the amino acid sequence of positions 1-473 of SEQ ID NO: 1; or (ii) is a variant of (i), wherein the amino acid sequence of the variant comprises less than 20 amino acid alterations as compared to the amino acid sequence of (i).

16. The process of claim 12, wherein the cellobiose oxidase comprises the amino acid sequence of positions 1-473 of SEQ ID NO: 1.

17. The process of claim 12, wherein the particles have a particle diameter (D(v,0.1)) distribution of at least 0.1 μm and a particle diameter (D(v,0.9)) distribution of less than 200 μm.

18. The process of claim 12, wherein the particles are of at least one particle type selected from cellulose and cellulose derivatives, agarose, dextran, polyacrylate,. polystyrene, polyacrylamide, polymethacrylate, copolymers, and casein glycomacropeptide (CGMP) oligomer particles, wherein the CGMP oligomer particles comprise CGMP oligomers cross-linked via intermolecular covalent isopeptide bonds, wherein the CGMP oligomers are oligomers of monomeric CGMP having the amino acid sequence of amino acid residues 106-169 of κ-casein.

19. The process of claim 1, wherein the cellobiose oxidase comprises the amino acid sequence of positions 1-473 of SEQ ID NO: 1.


SEQUENCE LISTING (2 sequences)

SEQ ID NO: 1 - protein, 473 aa, Microdochium nivale
  LOX
GAIEACLSAAGVPIDIPGTADYERDVEPFNIRLPYIPTAIAQTQTTAHIQSAVQCAKKLNLKVSAKSGGHSYASFGFGGENGHLMVQLDRMIDVISYNDKTGIAHVEPGARLGHLATVLNDKYGRAISHGTCPGVGISGHFAHGGFGFSSHMHGLAVDSVVGVTVVLADGRIVEASATENADLFWGIKGAGSNFGIVAVWKLATFPAPKVLTRFGVTLNWKNKTSALKGIEAVEDYARWVAPREVNFRIGDYGAGNPGIEGLYYGTPEQWRAAFQPLLDTLPAGYVVNPTTSLNWIESVLSYSNFDHVDFITPQPVENFYAKSLTLKSIKGDAVKNFVDYYFDVSNKVKDRFWFYQLDVHGGKNSQVTKVTNAETAYPHRDKLWLIQFYDRYDNNQTYPETSFKFLDGWVNSVTKALPKSDWGMYINYADPRMDRDYATKVYYGENLARLQKLKAKFDPTDRFYYPQAVRPVK

SEQ ID NO: 2 - protein, 546 aa, Chondrus crispus
  HOX
MATLPQKDPGYIVIDVNAGTPDKPDPRLPSMKQGFNRRWIGTNIDFVYVVYTPQGACTALDRAMEKCSPGTVRIVSGGHCYEDFVFDECVKAIINVTGLVESGYDDDRGYFVSSGDTNWGSFKTLFRDHGRVLPGGSCYSVGLGGHIVGGGDGILARLHGLPVDWLSGVEVVVKPVLTEDSVLKYVHKDSEGDDGDLFWAHTGGGGGNFGIITKYYFKDLPMSPRGVIASNLHFSWDGFTRDALQDLLTKYFKLARCDWKNTVGKFQIFHQAAEEFVMYLYTSYSNDAEREVAQDRHYHLEADIEQIYKTCEPTKALGGHAGWAPFPVRPRKRHTSKTSYIHDETMDYPFYALTETINGSGPNQRGKYKSAYMIKDFPDLQIDVIWKYLTEVPDGLTSAEMKDALLQVDMFGGEIHNVAWDATAVAQRKYIIKLQYQTYWQEEDKDAVNLKWIRDFYEEMYEPYGGVPDPNTQVESGKGVFEGCYFNYPDVDLNNWKNGKYGALELYFLGNLNRLIKAKKLWDPNEIFTNKQSIPTKSLKEYKQTK